(19) United States
(12) Patent Application Publication
(10) Pub. No.: US 2008/0255797 A1
(43) Pub. Date: Oct. 16, 2008

(54) System for Measuring Pedal Speed

(75) Inventors: Lionel Cordesses, Montigny (FR); Mehdi Gati, Antony (FR); Ophelie Thomassin, Rueil Malmaison (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 11/575,404

(22) PCT Filed: Sep. 7, 2005
(86) PCT No.: PCT/FR05/50719

§ 371 Date: Mar. 16, 2007

(30) Foreign Application Priority Data
Sep. 22, 2004 (FR) 0409990

(51) Int. Cl. G01P 11/00

(52) U.S. Cl. 702/149

(57) ABSTRACT

The invention concerns a detecting system for measuring the speed (V) of a pedal comprising a pedal (1), a first sensor (11) for sensing the position of the pedal delivering a first signal (c1) indicating the passage of a first position by the pedal, a second position sensor (12) delivering a second signal (c2) indicating the passage of a second position by the pedal (1), a calculator receiving the signals c1 and c2, the calculator (2) comprising means for measuring the intermediate time (&Dgr;t) of the pedal between the first (a1) and the second (a2) position to determine the travelling speed (V) of the pedal.

The invention relates to a system for measuring a pedal speed, in particular for detecting an emergency braking situation for a motor vehicle.

When a driver is driving a motor vehicle, he encounters emergency situations in which he wishes to stop or heavily slow the vehicle within a very short period. For this, he presses rapidly and strongly upon a brake pedal.

It has been proposed to detect this situation in order in these emergency situations to provide additional assistance to the brake system. Document U.S. Pat. No. 5,607,209 proposes a system in which a computer receives information indicating the pressure in a hydraulic braking circuit. The computer calculates a speed of variation of the pressure and, if this speed exceeds a predetermined threshold, diagnoses an emergency situation. In this case, the computer instructs assistance means to provide supplementary assistance to the brake system.

Emergency situation detection systems are also known in which a sensor detects that the pedal has reached the depression travel limit. The emergency situation therefore corresponds to the situation in which the driver has pressed the brake pedal to the end of its travel.

However, the system of document U.S. Pat. No. 5,607,209 requires at least one pressure sensor and a digitalization device for the signal leaving the sensor. Moreover, the system with detector at the travel limit does not allow account to be taken of the speed of depression of the pedal. It only allows the emergency situation to be detected once the pedal reaches the travel limit.

An object of the invention is therefore to propose a simple system for measuring a pedal speed.

With this object in mind, the subject of the invention is a detection system for measuring a pedal speed, comprising a pedal and a first position sensor for the pedal, a computer receiving a first signal from the first sensor indicating the passing of a first position by the pedal. The system additionally comprises a second position sensor delivering a signal indicating the passing of a second position by the pedal, the computer comprising means for measuring the time it takes for the pedal to pass between the first and the second position in order to determine the speed of displacement of the pedal.

A pedal speed determining system is thus obtained which is simple, since it only utilizes two position sensors, such as mechanical contacts. Optical, magnetic or, indeed, Hall sensors can also be used.

Preferably, the speed is determined by dividing a distance between the first and the second sensor by the passage time. The distance is linear in the case of a sliding pedal, or angular in the case of a pivoting pedal.

According to one embodiment, the passage time is measured by a number of clock pulses during the passage time.

According to one embodiment, the passage time is measured by the rise in an electrical value during the passage time.

More particularly, the pedal is a brake pedal, the computer determining an occurrence of an emergency situation if the pedal is depressed and if the depression speed is greater than a predetermined threshold.

Preferably, the first position is situated at one-third of the travel after the start of the pedal travel, and the second position is situated at two-thirds of the travel after the start of the pedal travel. The speed information is thus obtained before the travel limit is reached.

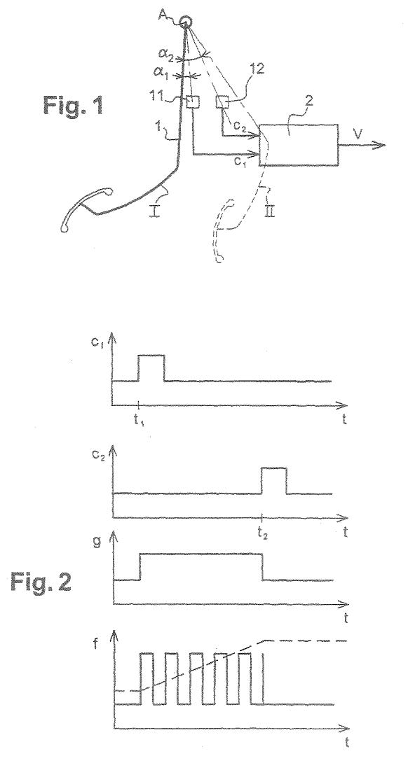

The invention will be better understood and other features and advantages will emerge from a reading of the following description, the description making reference to the appended drawings, wherein:
FIG. 1 is a schematic view of a system according to the invention;
FIG. 2 is a time diagram of different signals.

A system according to the invention is represented schematically in FIG. 1. The system comprises a pedal 1, for example a brake pedal, mounted pivotably about a shaft A fixedly connected to the body of a motor vehicle (not represented). The pedal 1 is movable between a starting position I, represented in solid lines in FIG. 1, and a depressed position II, represented in dash-dot lines, in which latter position the pedal is at the travel limit.

The system additionally comprises a first 11 and a second sensor 12 fixedly attached to the body. The sensors respectively deliver a first c1 and a second signal c2 to a computer 2. The computer 2 delivers a speed signal V representing the angular speed V of depression or release of the pedal.

As can be seen in FIG. 2, the signals c1 and c2 are binary signals. The first signal c1 commutates when the pedal 1 passes through a first position after pivoting by a first angle α1 from the starting position I.

Similarly, the second signal c2 commutates when the pedal 1 passes through a second position after pivoting by a second angle α2 from the starting position I.

When a driver presses on the pedal 1 and the pedal 1 passes from the starting position I to the depression position II, the signal c1 passes into a high state at an instant t1 as the pedal 1 passes in front of the first sensor 11, then reverts to a low state once this sensor is passed, as is shown by FIG. 2. Similarly the second signal c2 passes into a high state at an instant t2 as the pedal 1 passes in front of the second sensor 12, then reverts to a low state once this sensor is passed.

In one particular embodiment, a signal g is generated by the computer. The signal g passes from the low state to the high state over an ascending front of c1 at the instant t1, and passes from the high state to the low state over an ascending front of c2 at the instant t2 The computer then determines the passage time Δt, which is the period during which the signal g is in the high state. This passage time Δt can be determined, in a first variant, by the final voltage or intensity of an electrical signal f evolving linearly from an initial value and at a predetermined rate of growth while the signal g is in the high state. The voltage or the intensity reached at the instant t2 represents the passage time Δt.

In a second variant, the computer 2 counts the number of pulses of a signal f which transmits an interrupted clock signal at a predetermined frequency while the signal g is in the high state. The number of pulses for example obtained by counting the number of descending fronts of the clock signal, divided by the frequency of the clock, represents the passage time Δt.

From the information indicating the passage time Δt, the computer determines an estimate of the angular speed of displacement of the pedal, based on the formula:

V=(α2−α1)/Δt.

The computer then delivers the signal V to other computers or uses it for other procedures. Should the pedal be a brake pedal as in the illustrated prior art, the signal V can serve to determine the occurrence of an emergency situation if the speed V is greater than a predetermined threshold. For a vehicle equipped with a clutch-type assistance system, the depression speed can be used to modify the law of assistance.

The invention is not limited to the embodiment which has just been described by way of example. The pedal can be of the linear displacement type, the positions of the sensors being expressed in linear distance. The system can likewise indicate in a complementary manner the direction of displacement (depression or release of the pedal).

1-7. (canceled)

8. A detection system for measuring a pedal speed, comprising:
a pedal;
a first position sensor for the pedal;
a computer receiving a first signal from the first position sensor indicating passing of a first position by the pedal;
a second position sensor delivering a second signal indicating passing of a second position by the pedal;
the computer comprising means for measuring the time it takes for the pedal to pass between the first and the second positions to determine speed of displacement of the pedal.

9. The system as claimed in claim 8, in which the speed is determined by dividing a distance between the first and the second positions by the passage time

10. The system as claimed in claim 9, in which the passage time is measured by a number of clock pulses during the passage time.

11. The system as claimed in claim 9, in which the passage time is measured by rise in an electrical value during the passage time.

12. The system as claimed in claim 9, in which the pedal is a brake pedal, the computer determining an occurrence of an emergency situation if the pedal is depressed and if the depression speed is greater than a predetermined threshold.

13. The system as claimed in claim 8, in which the first position is situated at one-third of the travel after start of travel of the pedal.

14. The system as claimed in claim 8, in which the second position is situated at two-thirds of the travel after start of travel of the pedal.
